(19) United States
(12) Patent Application Publication
(10) Pub. No.: US 2002/0071062 A1
(43) Pub. Date: Jun. 13, 2002

(54) Screen detachable and updateable audio and video radio frequency device

(76) Inventor: Jefferson Liu, Taichung (TW)

Correspondence Address: Keith Kline, PRO-TECHTOR INTERNATIONAL SERVICES, 20775 Norada Court, Saratoga, CA, 95070-3018, US

(21) Appl. No.: 10/004,609

(22) Filed: Oct. 27, 2001

(30) Foreign Application Priority Data
Dec. 8, 2000 (TW) 089221386

(51) Int. Cl. H04N 5/64

(52) U.S. Cl. 348/838; 348/839

(57) ABSTRACT

A screen detachable and updateable A/V radio frequency device includes a motherboard and a keyboard, at least one wireless A/V transmitter, a wired A/V signal and power wire, an assembling-joint A/V signal and power wire and at least one random display device. The motherboard and the keyboard are installed on a notebook computer, i.e., a palm computer or a pocket type compute. The wireless A/V transmitter is installed within the mainframe. One end of the wired A/V signal and power wire is connected to the audio/video signal and power wire and another end thereof is connected to the wireless A/V transmitter. One end of the assembling-joint A/V signal and power wire is connected to the audio/video signal and power wire and another end thereof is connected to an assembling joint.

### BACKGROUND OF THE INVENTION

1. Field of the invention

The present invention relates to a screen detachable and updateable A/V radio frequency device, and particularly to wireless A/V transmitter which may be wiredly connected to a mainframe and a random liquid crystal display, or has a mainframe, the mainframe 310 wirelessly transfers audio/video signals to change screen of an external wireless receiving and display device.

2. Description of the Related Art

FIGS. 1A and 1B shows a conventional notebook computer which has the functions of being folded and storage. However, the size of the general used random liquid crystal display is too smaller and can not be updated by a large liquid crystal display, a cathode ray tube display, or a TV screen. It is necessary to develop the technology for updating the display screen. If in updating process, the random display device is not detached, then the random display device will shield the vision of eyes. Moreover, the signals transmitted are possibly hindered.

### SUMMARY OF THE INVENTION

Accordingly, the primary object of the present invention is to provide a screen detachable and updateable A/V radio frequency device, wherein the wireless A/V transmitter includes a mainframe, The audio/video radio frequency device includes a motherboard and a keyboard, at least one wireless A/V transmitter, a wired A/V signal and power wire, an assembling-joint A/V signal and power wire and at least one random display device. The motherboard and the keyboard are installed on a notebook computer (i.e., a palm computer or a pocket type computer). A mainframe is detachable from the random display device. The detached mainframe may be used with the compatible the wireless video signal and audio signal receiving device of the external wireless receiving and display device.

Another object of the present invention is to provide a screen detachable and updateable A/V radio frequency device, wherein the wireless A/V transmitter includes a mainframe, The audio/video radio frequency device includes a motherboard and a keyboard, at least one wireless A/V transmitter, a wired A/V signal and power wire, an assembling-joint A/V signal and power wire and at least one random display device. Each wireless A/V transmitter is installed within the mainframe for providing the functions of digital A/V signal processing, modulation and transmitting.

A further object of the present invention is to provide a screen detachable and updateable A/V radio frequency device, wherein the wireless A/V transmitter includes a mainframe. The audio/video radio frequency device includes a motherboard and a keyboard, at least one wireless A/V transmitter, a wired A/V signal and power wire, an assembling-joint A/V signal and power wire and at least one random display device. One end of the wired A/V signal and power wire is connected to the audio/video signal and power wire and another end thereof is connected to the wireless A/V transmitter. An audio/video signal and power wire near the mainframe serves to supply power to the wireless A/V transmitter and transfer audio/video signal and power wire.

A still object of the present invention is to provide a screen detachable and updateable A/V radio frequency device, wherein the wireless A/V transmitter includes a mainframe, The audio/video radio frequency device includes a motherboard and a keyboard, at least one wireless A/V transmitter, a wired A/V signal and power wire, an assembling-joint A/V signal and power wire and at least one random display device. One end of the assembling-joint A/V signal and power wire is connected to the audio/video signal and power wire and another end thereof is connected to an assembling joint for detaching or assembling the random display device.

An yet object of the present invention is to provide a screen detachable and updateable A/V radio frequency device, wherein the wireless A/V transmitter includes a mainframe. The audio/video radio frequency device includes a motherboard and a keyboard, at least one wireless A/V transmitter, a wired A/V signal and power wire, an assembling-joint A/V signal and power wire and at least one random display device. The random display device is a general random liquid crystal display which is connected to the assembling-joint A/V signal and power wire so as to receive the signals from the mainframe directly and can be connected to other wired display through assembling joints.

The other object of the present invention is to provide a screen detachable and updateable A/V radio frequency device, wherein the wireless A/V transmitter includes a mainframe. The audio/video radio frequency device includes a motherboard and a keyboard, at least one wireless A/V transmitter, a wired A/V signal and power wire, an assembling-joint A/V signal and power wire and at least one random display device. The external wireless receiving and display device receives wireless modulation signals from the wireless A/V transmitter. The external wireless receiving and display device may be a TV type display, a flat type display, a plasma display or a general random liquid crystal display.

The various objects and advantages of the present invention will be more readily understood from the following detailed description when read in conjunction with the appended drawing.

### BRIEF DESCRIPTION OF THE DRAWINGS

FIG. 1A is an assembled view of a convention notebook computer.

FIG. 1B is a circuit block diagram of a conventional notebook computer.

FIG. 2A is an assembled view of the present invention.

FIG. 2B is a circuit block diagram of the present invention.

FIG. 3 shows one embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

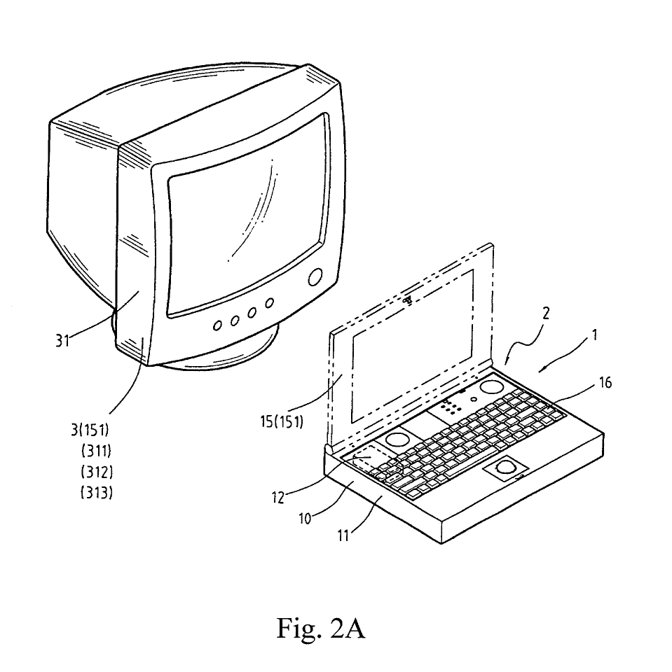

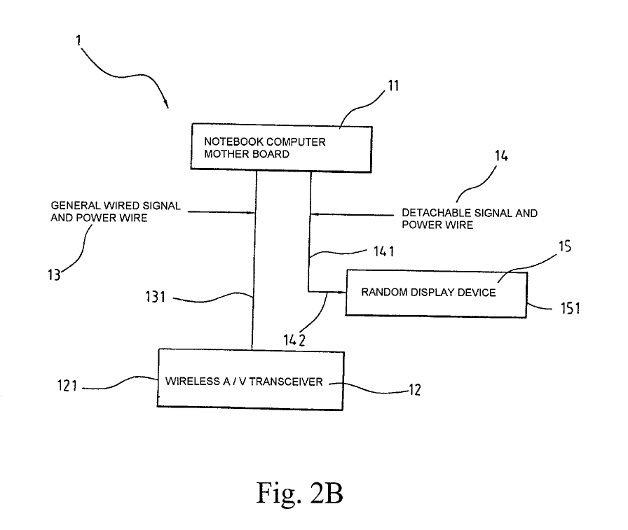

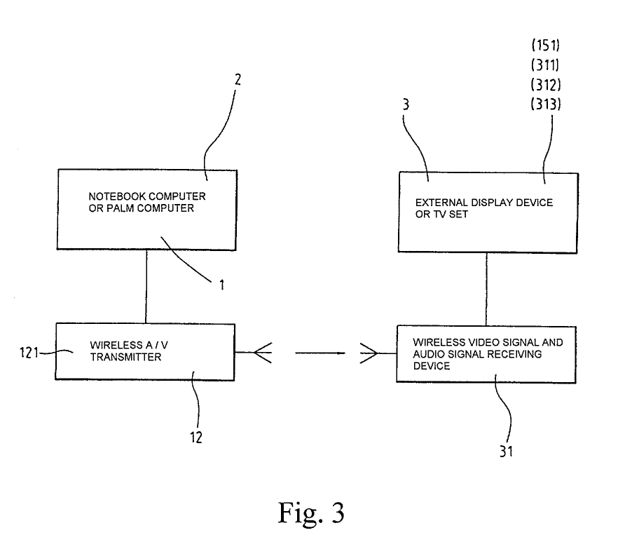

Referring to FIGS. 2A, 2B and 3, the embodiment of the present invention is illustrated. The present invention provides a screen detachable and updateable A/V radio frequency device. The audio/video radio frequency device 1 includes a motherboard 11 and a keyboard 16, at least one wireless A/V transmitter 12, a wired A/V signal and power wire 13, an assembling-joint A/V signal and power wire 14 and a random display device 15.

The motherboard 11 and the keyboard 16 are installed on a notebook computer 2 (i.e., a palm computer or a pocket type computer). A mainframe 10 is detachable from the random display device 15. The detached mainframe 10 may be used with the compatible wireless video signal and audio signal receiving device 31 of the external wireless receiving and display device 3 (referring to FIGS. 2A and 2B).

This wireless A/V transmitter 12 is installed near the mother board 11 and the keyboard 16 for providing the functions of digital A/V processing, modulation and emitting and includes a wireless A/V transmitter 121 (referring to FIGS. 2B and 3).

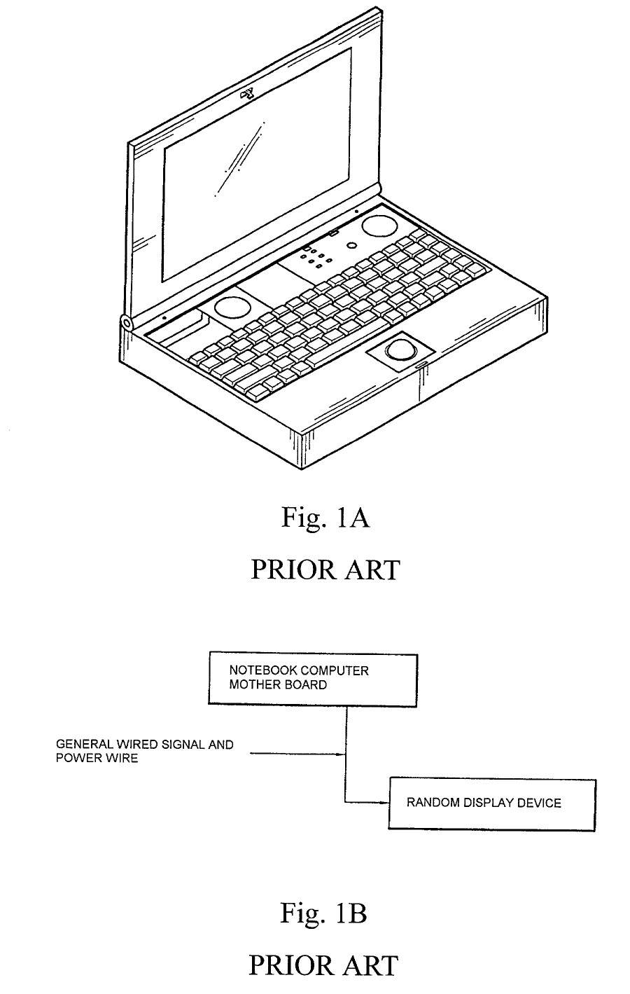

One end of the wired A/V signal and power wire 13 is connected to the audio/video signal and power wire near the wireless A/V transmitter 12. By the audio/video signal and power wire near the motherboard 11 to supply power to the wireless A/V transmitter 12 and provides A/V transfer signal. The wired A/V signal and power wire 13 may be a general wired signal and power wire 131 (referring to FIGS. 1B and 2B).

One end of the assembling-joint A/V signal and power wire 14 is assembled to the audio/video signal and power wire near the motherboard 11. The assembling-joint A/V signal and power wire 14 may be a detachable signal and power wire 141 having assembling-joint 142 (referring to FIG. 2B).

The random display device 15 may be a general random liquid crystal display 151, which is connected to the assembling-joint 142 at another end of the assembling-joint A/V signal and power wire 14 for directly receiving the circuit signals of the audio/video signal and power wire near the motherboard 11. After the random display device is detached, the motherboard 11 of the mainframe 10 is changeable by wirelessly transmitting A/V signals of the wireless video signal and audio signal to the receiving device 31 of the wireless receiving display. The wireless receiving display 3 may be a TV type display 311, a flat type display 151, a plasma display 312 or a general type display 313 (referring to FIGS. 2A, 2B and 3).

The advantages of the present invention is:

1. As the mainframe is detached, other compatible external wireless receiving and display device may be changed. Thereby, communication can be performed conveniently, the screen can be selected and data can be transferred randomly.

2. The wireless A/V transmitter may provide the function of digital A/V signal processing, modulation and transmitting. The operation is convenient and easy.

3. The wired A/V signal and power wire provides power to the mainframe and provides A/V signals to the wireless A/V transmitter. The design work is easy.

4. The assembling-joint A/V signal and power wire provides assembling joint which can be assembled and detached easily.

5. The random display device can directly receive signals from the audio/video signal and power wire near the mainframe and can be connected to other wire random display device through assembly joints.

6. The external wireless receiving and display device can receive wireless modulation signals from other mainframe Thereby, the wireless A/V transmitter. The operation is convenient and safe.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A screen detachable and updateable A/V radio frequency device comprising:
at least one mother board and one keyboard;
at least one wireless A/V transmitter installed in the interior of the mainframe for providing functions of digital A/V signals processing, modulation and transmitting;
a wired A/V signal and power wire having one end connected to an audio/video signal and power wire near the mainframe, and another end thereof being connected to said wireless A/V transmitter, by the audio/video signal and power wire near the mainframe to provide power to said wireless A/V transmitter and transfer A/V signals;
an assembling-joint A/V signal and power wire having one end connected the audio/video signal and power wire near the mainframe, and another end thereof being connected to an assembling joint; and
at least one random display device connected to the assembling joint of said assembling-joint A/V signal and power wire;
wherein said random display device directly receives the signals from said audio/video signal and power wire near the mainframe, and provides wireless A/V signals from a wireless transmission mainframe to other external wireless receiving and display device through said wireless A/V transmitter.

2. The screen detachable and updateable A/V radio frequency device as claim in claim 1, wherein the external wireless receiving and display device is a TV type display.

3. The screen detachable and updateable A/V radio frequency device as claim in claim 1, wherein the external wireless receiving and display device is a flat type display.

4. The screen detachable and updateable A/V radio frequency device as claim in claim 1, wherein the external wireless receiving and display device is a plasma display.

5. The screen detachable and updateable A/V radio frequency device as claim in claim 1, wherein the external wireless receiving and display device is a general random liquid crystal display.
